(19) United States
(12) Patent Application Publication
(10) Pub. No.: US 2006/0088399 A1
(43) Pub. Date: Apr. 27, 2006

(54) Toggle

(76) Inventor: Terenci G. DeMeo, North York (CA)

Correspondence Address: Elias C. Borges, Suite 406, 555 Burnhamthorpe Road, Toronto, ON, M9C 2Y3, CA

(21) Appl. No.: 11/296,455

(22) Filed: Dec. 8, 2005

Related U.S. Application Data
(63) Continuation-in-part of application No. 10/782,891, filed on Feb. 23, 2004.

(51) Int. Cl. F16B 21/00

(52) U.S. Cl. 411/340

(57) ABSTRACT

The present invention is a toggle fastener for providing a means to attach a screw to a drywall wall. The toggle consists of a unitary toggle member having a wing portion and an elongated tongue portion. The wing portion has a width and opposite ends, the elongated tongue portion extending perpendicularly from a center portion on the wing portion between the opposite ends. The tongue portion has a width and a substantially flat cross sectional profile with opposite edges. The width of the tongue portion extends perpendicularly across the width of the wing portion, the wing portion having a wing aperture passing through the wing at a point on the wing adjacent the elongated tongue. The toggle member is made of a flexible polymeric material selected to permit the tongue portion to resiliently bend between a first position wherein the tongue extends perpendicularly away from the wing and a second position wherein the tongue is parallel to and overlays the wing portion. The fastener further includes a nut member having a barrel portion and a washer portion, the nut member having a first aperture dimensioned and configured to snugly receive the tongue portion and a second aperture. The first and second apertures are dimensioned and configured such that the second aperture is substantially coaxially aligned with the wing aperture when the tongue portion is held perpendicular to the wing portion and the nut member is mounted to the tongue portion by passing the tongue portion through the first aperture.

### CROSS REFERENCE TO RELATED APPLICATION

This is a Continuation-in-part of application Ser. No. 10/782,891 filed Feb. 23, 2004, the entirety of which is incorporated herein by reference.

### FIELD OF THE INVENTION

The invention relates generally to toggles for facilitating the placement of mounting screws on drywall, wall boards, wall paneling or other similar building materials.

### BACKGROUND OF THE INVENTION

When a picture or other heavy object is to be mounted onto a drywall wall, it is possible to simply drive a mounting screw into the wall. Unfortunately, simply driving a screw into a drywall wall is not desirable for several reasons. Firstly, the drywall wall will likely be damaged by the process of driving the screw into the wall. Secondly, the screw will not be strongly anchored to the wall and will fall out if any significant force is applied to the screw. In order to strongly anchor a mounting screw to a drywall wall, a toggle is generally required. One type of toggle consists of a plastic or soft metal tube which is inserted into a pre-drilled hole in the drywall. The screw is then driven into the tube. The tube is configured to expand when the screw is driven into the tube, causing the tube to grip the drywall. This type of toggle is only suitable for light applications since the tube is frictionally held within the pre-drilled hole. Another type of toggle employs a spring biased hinged wing and screw combination. This toggle consists of a spring biased wing which is hinged in its center such that the wing can fold up. The wing is treaded onto a mounting screw or bolt at the hinge. To use this toggle, a large hole is first drilled into the drywall. The user then folds up the wing, threads it onto one end of the screw (or bolt) and then inserts the toggle (wing first) into the hole until the wing passes to the inside of the drywall wall. Once inside the wall, the spring biased wing unfolds, preventing it from being forced back out through the hole. This type of toggle enable the mounting screw (or bolt) to be very strongly anchored to the wall. Unfortunately, this type of toggle requires a fairly long mounting screw (or bolt). The longer the mounting bolt, the more awkward it is to use since a long portion of bolt will extend outside of the hole. Also, if the screw is removed from the wing by turning the screw, the wing falls into the wall and is lost. A new toggle will then have to be inserted into the wall. Furthermore, the hole drilled into the drywall must be relatively large in order to accommodate the folded wing, which results in a loosely fitting screw or bolt.

### SUMMARY OF THE INVENTION

The present invention overcomes the disadvantages of the prior art by providing a toggle fastener consisting of a unitary toggle member having a wing portion and an elongated tongue portion. The wing portion has a width and opposite ends, the elongated tongue portion extending perpendicularly from a center portion on the wing portion between the opposite ends. The tongue portion has a width and a substantially flat cross sectional profile with opposite edges. The width of the tongue portion extends perpendicularly across the width of the wing portion, the wing portion having a wing aperture passing through the wing at a point on the wing adjacent the elongated tongue. The toggle member is made of a flexible polymeric material selected to permit the tongue portion to resiliently bend between a first position wherein the tongue extends perpendicularly away from the wing and a second position wherein the tongue is parallel to and overlays the wing portion. The fastener further includes a nut member having a barrel portion and a washer portion, the nut member having a first aperture dimensioned and configured to snugly receive the tongue portion and a second aperture. The first and second apertures are dimensioned and configured such that the second aperture is substantially coaxially aligned with the wing aperture when the tongue portion is held perpendicular to the wing portion and the nut member is mounted to the tongue portion by passing the tongue portion through the first aperture.

With the foregoing in view, and other advantages as will become apparent to those skilled in the art to which this invention relates as this specification proceeds, the invention is herein described by reference to the accompanying drawings forming a part hereof, which includes a description of the preferred typical embodiment of the principles of the present invention.

### DESCRIPTION OF THE DRAWINGS

FIG. 1. is a perspective view of the wing portion of the present invention.

FIG. 2. is a perspective view of the present invention in its folded orientation being inserted into a wall.

FIG. 3. is a cross-sectional view of the present invention after being inserted into a wall.

FIG. 4. is a perspective view of the wing portion of the present invention with the nut portion of the present invention being mounted thereto.

In the drawings like characters of reference indicate corresponding parts in the different figures.

### DETAILED DESCRIPTION OF THE INVENTION

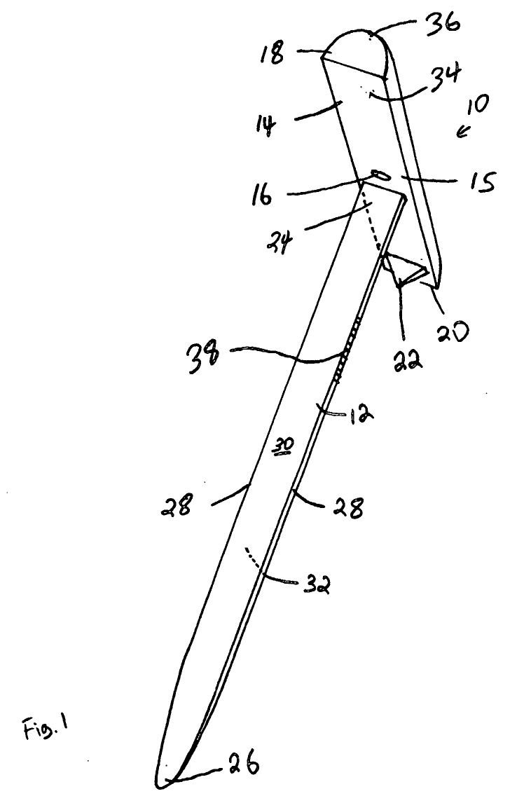

Referring firstly to FIG. 1, the toggle portion of the present invention, shown generally as item 10, consists of a unitary polymer member having an elongated flat tongue portion 12 extending perpendicularly from center 15 of an integral wing portion 14. Wing portion 14 is elongated and has opposite ends 18 and 20, flat surface 34 and opposite curved surface 36. Spike 22 is formed on surface 34 towards end 20. Curved surface 36 provides the wing portion with structural strength and stiffness. Aperture 16 passes perpendicularly through wing portion 14 at the center 15. Elongated flat portion 12 has opposite ends 24 and 26. End 26 is preferably tapered, while end 24 projects from center 15 adjacent aperture 16. Portion 12 has opposite flat surfaces 30 and 32 extending perpendicularly relative to flat surface 34 of wing 14. Portion 12 has opposite edges 28. Ridges 38 may be formed along edges 28. Toggle 10 is made from a single piece of polymeric material such as soft nylon. The material forming toggle 10 is selected to be sufficiently ductile to permit tongue portion 12 to bend at end 24 without breaking such that the tongue portion and wing portion 14 are substantially parallel to each other. The material forming toggle 10 is further selected to be sufficiently resilient to permit tongue portion 12 to return to its perpendicular orientation after it has been bent. Furthermore, the polymeric material forming toggle 10 is selected to be sufficiently stiff to permit spike portion 22 to dig into the surface of a wall (not shown) when it is urged against the wall by pulling on tongue portion 12. Finally, the material forming toggle 10 is selected to be sufficiently strong such that a user can pull on tongue portion 12 with a force of several kilograms without the tongue portion breaking. The polymeric material best suited is soft nylon. Other polymeric materials such as polypropylene and polyurethane are unsuitable because they result in structure which is too stiff and too difficult to easily permit a screw to pass through aperture 16.

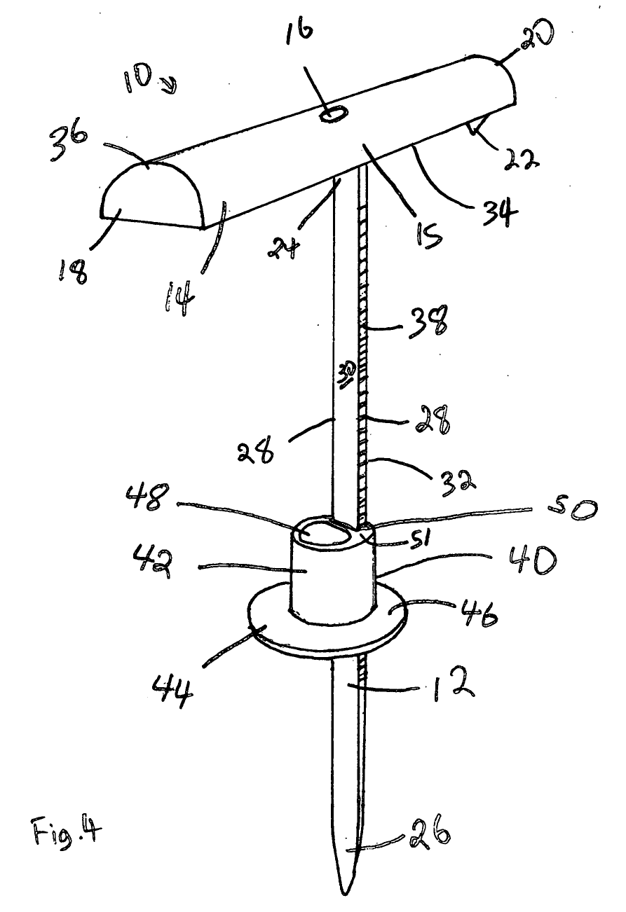

Referring now to FIG. 4, toggle 10 works in combination with nut 40. Nut 40 is a unitary member having barrel portion 42 and washer portion 44. Barrel portion 42 has aperture 48 and 50. Aperture 50 is dimensioned and configured to snugly receive tongue portion 12 such that nut 40 can be mounted to the tongue portion with the barrel portion oriented towards wing portion 14. Apertures 48 and 50 extend perpendicularly through barrel portion 42 parallel to each other. Apertures 48 and 16 are dimensioned and configured such that when nut portion 42 is mounted to toggle 10 as illustrated in FIG. 4 and flat member 12 is held straight, apertures 48 and 16 are coaxially aligned. Preferably, aperture 16 is slightly narrower than aperture 48. Aperture 50 is dimensioned and configured to tightly receive tongue portion 12 and position barrel portion 42 such that aperture 48 is adjacent surface 30 of the tongue portion. Preferably, aperture 50 is slot like to ensure that tongue portion 12 fits into the aperture in the correct orientation. Ridges 38 formed on edges 28 of tongue portion 12 are dimensioned and configured to act as a rachet against edges 51 of aperture 50, preventing nut portion 42 from slipping off tongue portion 12 after the nut portion has been mounted to the tongue portion. Barrel portion 42 is dimensioned and configured to have a diameter approximately the same as the diameter of wing portion 14. Nut 40 may be made of any rigid material, but preferably, it is made of a polymeric material having sufficient resilience and stiffness to mount tightly to tongue portion 12 when mounted to the tongue portion as illustrated in FIG. 4.

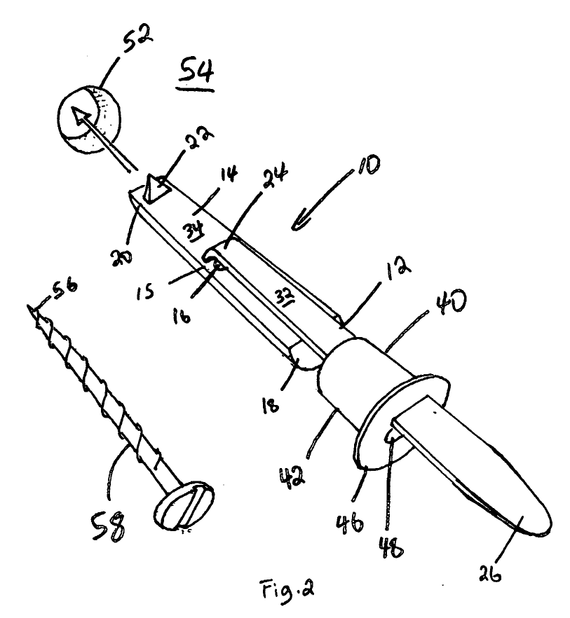

Referring now to FIG. 2, to use toggle 10, hole 52 is first drilled in wall 54. Hole 52 is made just a little wider than the thickness of wing 14. To insert the toggle through hole 52 in wall 54, flat member 12 is bent at end 24 such that the tongue portion is substantially parallel to wing portion 14. Preferably, tongue portion 12 is bent over surface 34 of wing 14 such that the tongue portion overlays end 18 leaving end 20 of the wing exposed. End 20 is then inserted through aperture 52 as illustrated. Tongue portion 12 is resilient so the user will have to hold wing portion 14 and the tongue portion in the orientation shown while the wing portion is inserted through hole 52. After wing portion 14 is fully inserted through hole 52, the resilience of tongue portion 12 permits wing portion 14 and the tongue portion to return to their original perpendicular orientation. The user may then mount nut 40 onto tongue 12 and urge the nut towards wing portion 14 by grasping onto end 26 of tongue portion 12. Nut 40 is urged towards wing 14 with sufficient force to insert barrel portion 42 into aperture 52. Flange portion 46 is dimensioned and configured to be wider than aperture 52, thereby preventing the nut to pass through the aperture. The user may then pass screw 58 through aperture 48 which will be aligned with aperture 16.

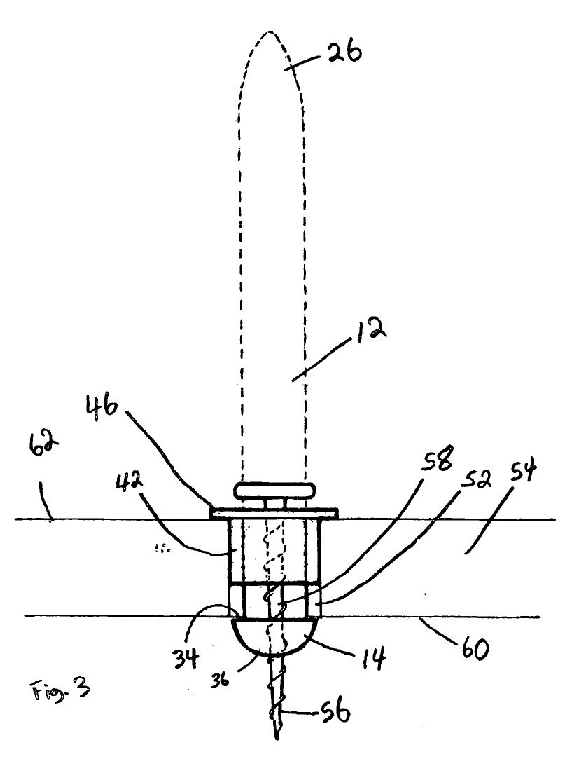

Referring now to FIG. 3, when the user pulls on tongue portion 12 with sufficient force, surface 34 of wing 14 is urged against surface 60 of wall 54. Washer 46 may also be urged against the wall such that the washer lies flat against wall surface 62. Screw 58 may then be easily travel through into barrel portion 42 and screw into wing portion 14. The excessive length of tongue portion 12 may be trimmed to create a neat finish.

Referring back to FIG. 1, tongue portion 12 is oriented perpendicularly to wing portion 14 such that the tongue portion surfaces 30 and 32 are perpendicular to surface 34 and the tongue portion extends across the width of wing portion 14. By having the tongue portion extend along the width of wing portion 14, it is easier to bend portion 14 such that surface 30 can lie relatively flush against surface 34. This flat orientation of portion 12 permits the portion to bend readily while allowing the portion to be sufficiently wide to resist pulling forces of several kilograms. If portion 12 had a circular or square cross sectional profile, then the portion would resist bending so much that its cross sectional diameter would have to be greatly reduced, thereby reducing its strength. Furthermore, as better illustrated in FIG. 4, with portion 12 having a flat cross sectional profile, it is easier to ensure that nut 40 is oriented in the right position such that apertures 48 and 16 are coaxially aligned.

A specific embodiment of the present invention has been disclosed; however, several variations of the disclosed embodiment could be envisioned as within the scope of this invention. It is to be understood that the present invention is not limited to the embodiments described above, but encompasses any and all embodiments within the scope of the following claims.

We claim:

1. A fastener toggle comprising:
a unitary toggle member having a wing portion and an elongated tongue portion, the wing portion having a width and opposite ends, the elongated tongue portion extending perpendicularly from a center portion on the wing portion between the opposite ends, the tongue portion having a width and a substantially flat cross sectional profile with opposite edges, the width of the tongue portion extending across the width of the wing portion, the wing portion having a wing aperture passing through the wing at a point on the wing adjacent the elongated tongue, the toggle member being made of a flexible polymeric material selected to permit the tongue portion to resiliently bend between a first position wherein the tongue is perpendicular to the wing and a second position wherein the tongue is parallel to and overlays the wing portion, and
a nut member having a barrel portion and a washer portion, the nut member having a first aperture dimensioned and configured to snugly receive the tongue portion and a second aperture, the first and second apertures extending through the barrel portion in parallel, the first and second apertures being dimensioned and configured such that the second aperture is substantially coaxially aligned with the wing aperture when the nut member is mounted to the tongue portion by passing the tongue portion through the first aperture and the tongue portion is held perpendicular to the wing portion.

2. The fastener of claim 1 wherein the tongue portion has a plurality of ridges.

3. The fastener of claim 1 wherein the tongue portion has a tapered end opposite the wing portion.

4. The fastener of claim 1 wherein the wing portion has a spike on one of its ends.

5. The fastener of claim 4 wherein the tongue portion is positioned between the spike and the wing aperture.

6. The fastener of claim 1 wherein the first aperture of the nut is dimensioned and configured to resist the removal of the tongue portion after the tongue portion is inserted through the first aperture.

7. A fastener toggle comprising:
a unitary toggle member having a wing portion and an elongated tongue portion, the wing portion having a width and opposite ends, the elongated tongue portion extending perpendicularly from a center portion on the wing portion between the opposite ends, the tongue portion having a width and a substantially flat cross sectional profile with opposite edges, the width of the tongue portion extending perpendicularly across the width of the wing portion, the wing portion having a wing aperture passing through the wing at a point on the wing adjacent the elongated tongue, the toggle member being made of a flexible polymeric material selected to permit the tongue portion to resiliently bend between a first position wherein the tongue extends perpendicularly away from the wing and a second position wherein the tongue is parallel to and overlays the wing portion, and
a nut member having a barrel portion and a washer portion, the nut member having a first aperture dimensioned and configured to snugly receive the tongue portion and a second aperture, the first and second apertures being dimensioned and configured such that the second aperture is substantially coaxially aligned with the wing aperture when the tongue portion is held perpendicular to the wing portion and the nut member is mounted to the tongue portion by passing the tongue portion through the first aperture.

8. The fastener of claim 7 wherein the tongue portion has a plurality of ridges.

9. The fastener of claim 7 wherein the tongue portion has a tapered end opposite the wing portion.

10. The fastener of claim 7 wherein the wing portion has a spike on one of its ends.

11. The fastener of claim 10 wherein the tongue portion is positioned between the spike and the wing aperture.

12. The fastener of claim 7 wherein the first aperture of the nut is dimensioned and configured to resist the removal of the tongue portion after the tongue portion is inserted through the first aperture.
